(19) United States
(12) Patent Application Publication
(10) Pub. No.: US 2005/0178580 A1
(43) Pub. Date: Aug. 18, 2005

(54) Conductor support

(76) Inventors: Joseph W. Holland, Boise, ID (US); John M. Bangerter, Boise, ID (US)

Correspondence Address: Joseph W. Holland;HOLLAND & THIEL, P.C., PO Box 1840, Boise, ID, 83701-1840, US

(21) Appl. No.: 10/851,700

(22) Filed: May 20, 2004

Related U.S. Application Data
(63) Continuation-in-part of application No. 10/779,209, filed on Feb. 13, 2004.

(51) Int. Cl. H01B 17/16

(52) U.S. Cl. 174/173

(57) ABSTRACT

A conductor support including a structural attachment member having a base element and a carrier arm connected to and extending from the base element. The carrier arm includes one or more apertures formed through a cross-section of the carrier arm, the apertures configured to permit insertion of a flexible cable connector. The flexible cable connector includes a connector body, a retainer engagement element and an insert end configured for insertion through the one or more apertures of the carrier arm. The conductor support also includes a connector retainer including a connector retaining element, the connector retaining element engagable with the retainer engagement element of the flexible cable connector to restrict pullout of the cable connector through the apertures.

### RELATED APPLICATIONS

This continuation-in-part utility patent application claims the priority of a utility patent application entitled CONDUCTOR SUPPORT, Ser. No. 10/779,209, filed with parts omitted Feb. 13, 2004, omitted parts filed, May 20, 2004.

### FIELD OF THE INVENTION

The present invention relates to a conductor support generally and more particularly to a conductor support which provides a means for securing one or more conductors at a selected spacing from an edge of a structural or framing member.

### BACKGROUND OF THE INVENTION

In conventional residential and commercial construction, some or all of the structure may be formed by connecting and erecting various structural or framing member components which may be themselves formed of wood, metal or other materials. Conductors for outlets, switches and fixtures are installed within the framework, often running parallel to the various structural or framing members. Following wiring, panels or other finishing members are secured to the face of the various framing member components covering portions of the electrical installment.

Since the various structural or framing members are commonly concealed as the panels or other finishing members are being fixed to the structural or framing members, fasteners may, on occasion, miss a structural or framing member and either hit directly or glance against concealed conductors. In doing so the integrity of the conductor may be jeopardized. Various building codes take this situation into consideration and may therefore specify that wiring be positioned a defined distance from the nearest edge of a structural or framing member. FIGS. 1 and 2 show two cable stackers CS1 and CS2 respectively, that hold one or more cable C near a centerline CL of a framing member FM. As seen, in either case a substantial portion of cable C extends beyond centerline CL and therefore cables C is not positioned a distance D from the face F of the framing member FM.

Also, it is common in construction to employ the use of metal staples when affixing conductors to structural or framing members. There exists a significant risk that in making such attachment, a point of a staple inadvertently pierces the insulating sheath of the conductor, creating a risk of short, failure of a circuit or the conductor itself at the location of the damage to the insulating sheath. Additionally, it is common for building codes to limit or prohibit stacking conductors, one on top of another, under a single staple.

Accordingly, there may be advantage found in providing a device for positioning cables, wiring or other conductors at a selected distance from an edge of a structural or framing member. Accordingly, advantage may be found in providing a device for positioning cables, wiring or other conductors in a stacked arrangement wherein a set distance is maintained between conductors attached to the support. The device should preferably be low in cost and readily installable utilizing existing tools for mounting and installation.

It is therefore one object of the present invention to provide a conductor support that provides fast and simple installation at a selected distance from an edge of a structural or framing member, and which permits positioning of cables, wiring or conductors at a selected distance from an edge of a structural or framing member. It is an additional object of the present invention to provide an alternative to the use of staples as a preferred means for attaching conductors to various structural or framing members. Additionally, it is an object of the present invention to provide a conductor support that permits the attachment of more than one conductor in a stacked arrangement without the use of a staple.

### SUMMARY OF THE INVENTION

The present invention is directed to a conductor support including a structural attachment member having a base element and a carrier arm connected to and extending from the base element. The carrier arm includes one or more apertures formed through a cross-section of the carrier arm, the apertures configured to permit insertion of a flexible cable connector. The flexible cable connector includes a connector body, a retainer engagement element and an insert end configured for insertion through the one or more apertures of the carrier arm. The conductor support of the present invention also includes a connector retainer including a connector retaining element. The flexible cable connector is placed about a conductor and the insert end of the flexible cable connector is inserted through one of the apertures formed in the carrier arm. The connector retaining element engages the retainer engagement element to restrict pullout of the cable connector. In this manner, the conductor is held securely against the carrier arm. The carrier arm may be configured to so hold a single conductor or two, three or more conductors in a stacked arrangement using a single flexible cable connector. In one preferred embodiment, the retainer engagement element cable comprises a plurality of teeth formed along a surface of the connector body. In one preferred embodiment, the connector retainer is formed integrally to the carrier arm and the connector retaining element is configured as a retaining pawl formed within an aperture located in the carrier arm for ratcheting engagement with the plurality of teeth formed along a surface of the connector body.

The present invention consists of the device hereinafter more fully described, illustrated in the accompanying drawings and more particularly pointed out in the appended claims, it being understood that changes may be made in the form, size, proportions and minor details of construction without departing from the spirit or sacrificing any of the advantages of the invention.

### DESCRIPTION OF THE DRAWINGS

FIGS. 1 and 2 are representative side views of two cable support devices according to the prior art;

FIGS. 3 and 4 are representative perspective views of a framed wall section wherein a conductor support according to the present invention is shown in use;

FIG. 5 is a representative perspective view of a conductor support according to the present invention;

FIG. 6 is a representative perspective view of an alternate embodiment of a conductor support according to the present invention;

FIG. 7 is a representative side view of a conductor support according to the present invention;

FIG. 8 is a representative side view of a conductor support according to the present invention;

FIG. 9 is a representative side view cutaway detail of a retainer engagement element and a connector retaining element of a conductor support according to the present invention;

FIG. 10 is a representative side view cutaway detail of a retainer engagement element and a connector retaining element of a conductor support according to the present invention;

FIG. 11 is a representative side view cutaway detail of a retainer engagement element and a connector retaining element of a conductor support according to the present invention;

FIG. 12 is a representative side view cutaway detail of a retainer engagement element and a connector retaining element of a conductor support according to the present invention;

FIG. 14 is a representative perspective view of an alternate embodiment of a conductor support according to the present invention;

FIGS. 15 and 16 are representative perspective views of a framed wall section wherein a conductor support according to an alternate embodiment of the present invention is shown in use;

FIG. 17 is a representative front view of an alternate embodiment of the present invention;

FIGS. 18A-18C are representative bottom views of an alternate embodiment of the present invention showing the slideably engagable carrier arms;

FIG. 19 is a representative front view cutaway detail of an alternate embodiment of the present invention;

FIG. 20 is a representative side view of an alternate embodiment of the present invention; and

FIG. 21 is a schematic diagram depicting a method for positioning and securing a conductor relative to a frame member according to the present invention.

### DETAILED DESCRIPTION

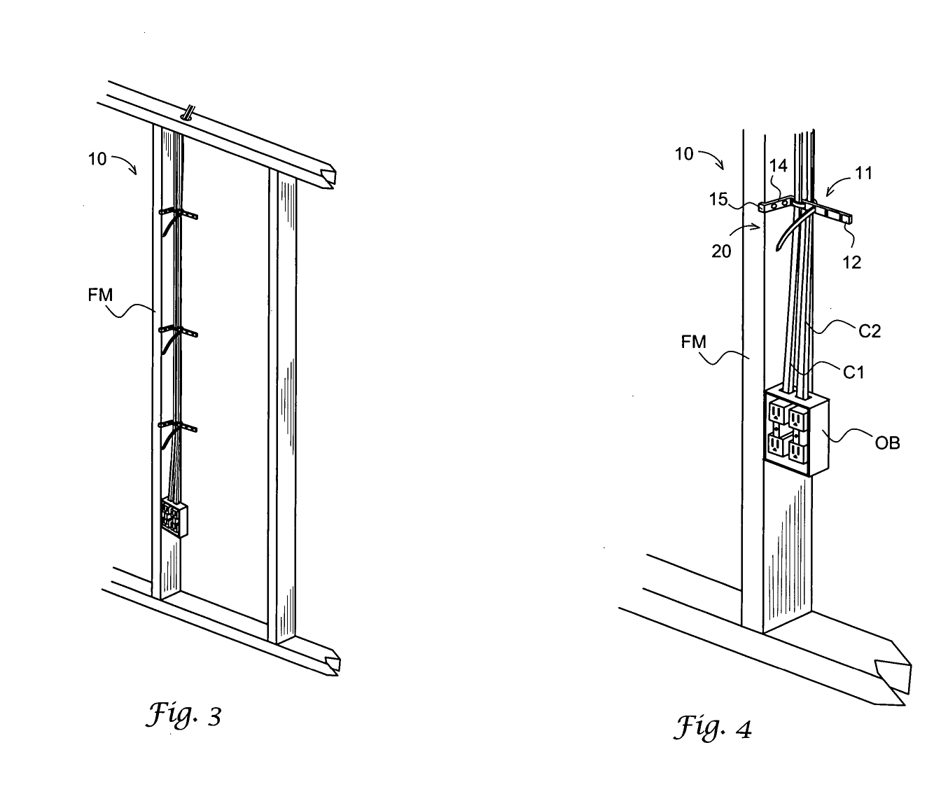

Referring to FIGS. 3 and 4, conductor support 10 is seen in use in an installed position attached to frame member FM. As seen in FIG. 4, conductors C1 and C2 run generally parallel to faming member FM into outlet OB. Conductors C1 and C2 attached conductor support 10 which includes structural attachment member 11 and a cable connector 20. Structural attachment member 11 includes base element 14 and carrier arm 12 connected to and extending from base element 14. In the preferred embodiment, base element 14 includes finger 15 connected to and extending from base element 14 with a substantially perpendicular orientation, with finger 15 extending in a direction generally opposite carrier arm 12.

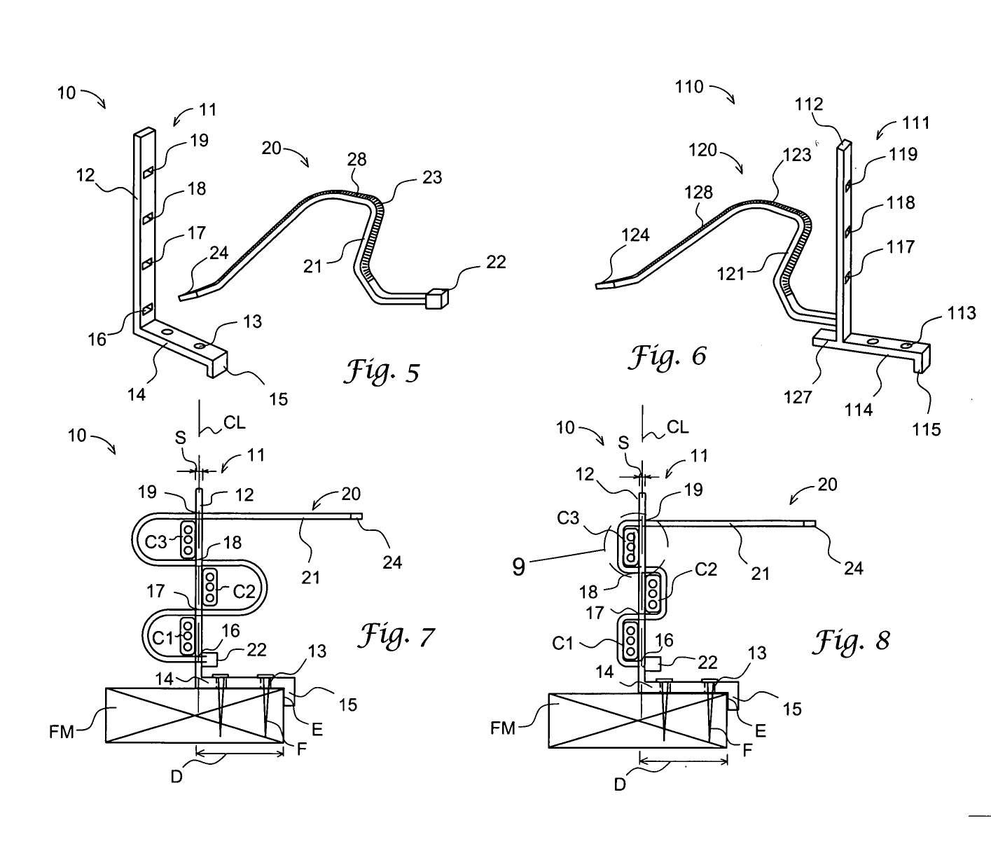

Referring to FIGS. 5, 7 and 8, in one preferred embodiment, conductor support 10 includes structural attachment member 11 and a cable connector 20. Structural attachment member 11 includes base element 14 and carrier arm 12 connected to and extending from base element 14. Carrier arm 12 is formed having apertures 16-19 formed through a cross-section of carrier arm 12. Base element 14 includes one or more apertures 13 formed through a cross-section of base element 14, apertures 13 being sized and configured for insertion and passage of a fastener, for instance a nail or screw, (not shown), for attaching structural attachment member 11 to a framing member as seen in FIGS. 3 and 4. In a preferred embodiment, structural attachment member 11 is formed of a resilient material such as plastic, nylon or a high modulus elastomer and can be manufactured through conventional injection molding techniques.

Cable connector 20 is preferably made of a flexible, resilient material such as plastic, nylon or a high modulus elastomer and can be manufactured through conventional injection molding techniques. As seen in FIG. 5, cable connector 20 includes a connector body 21, an insert end 24 and a head 22 formed at a second end. Cable connector 20 further includes a plurality of teeth 23 formed along a first surface 28 of connector body 21. Cable connector 20 is formed generally in a manner consistent with the manufacture of “cable ties” which are known in the art with the exception that head 22 need not include a retaining pawl for ratcheting engagement with the teeth 23 of cable connector 20. See for instance U.S. Pat. Nos.

3,484,905, 3,590,442, 3,672,003, 3,761,999 or

4,009,509, all of which are incorporated by reference herein. Insert end 24 is sized and configured for passage through apertures 16-19 of carrier arm 12. As shown in FIG. 5, conductor support 10 has the advantage of being capable of utilizing existing cable ties as a cable connector 20, thereby incorporating a readily available component in the product configuration.

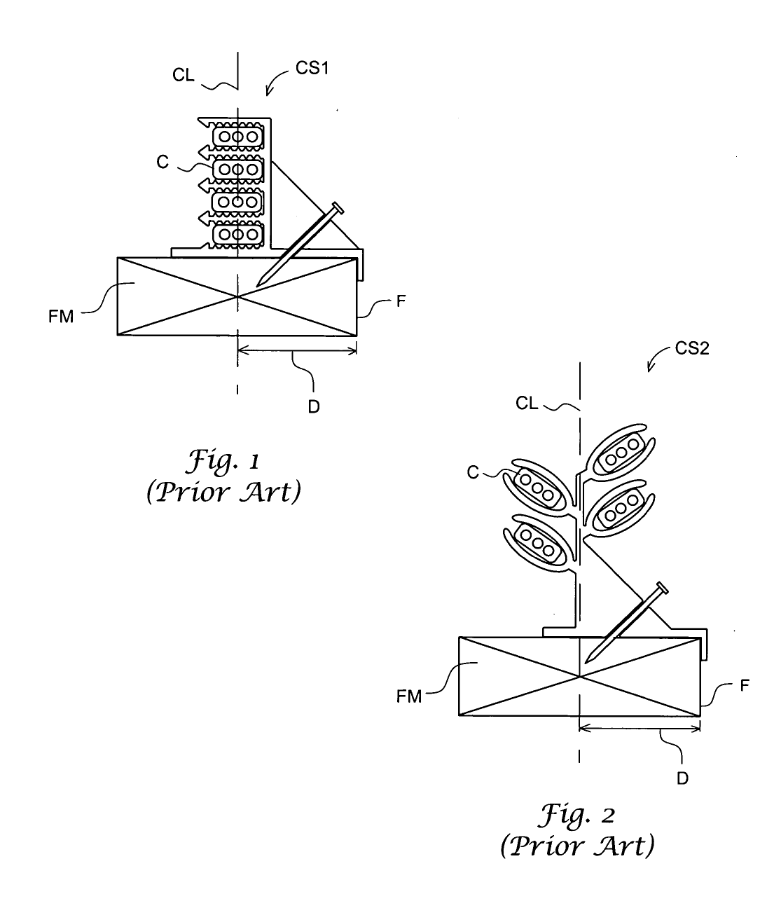

Referring to FIG. 6, an alternate preferred embodiment, conductor support 110 includes structural attachment member 111 and a cable connector 120. Structural attachment member 111 includes base element 114 and carrier arm 112 connected to and extending from base element 114. Carrier arm 112 is formed having apertures 117-119 formed through a cross-section of carrier arm 112. Base element 114 includes one or more apertures 113 formed through a cross-section of base element 114 for insertion and passage of a fastener, for instance a nail or screw, (not shown), for attaching structural attachment member 111 to a framing member as seen in FIGS. 1 and 2. In the embodiment shown in FIG. 6, base element 114 is formed including toe 127, which improves strength at the juncture of base element 114 and carrier arm 112.

As shown in FIG. 6, cable connector 120 is an integrally formed structure formed with or affixed to carrier arm 112. Cable connector 120 includes a plurality of teeth 123 spaced along a length of a top surface 128 of connector body 121. Insert end 124 is sized and configured for passage through apertures 116 -119 of carrier arm 112.

Referring to FIGS. 7 and 8, cable connector 20 is shown being employed to secure conductors C1-C3 in position relative to carrier arm 12 and frame member FM. Structural attachment member 11 includes base element 14 and carrier arm 12 connected to and extending from base element 14. Carrier arm includes an axis indicated by the reference CL and a thickness S. Base element 14 is shown positioned on framing member FM and includes apertures 13 formed through a cross-section of base element 14. Apertures 13 are sized and configured for insertion and passage of fasteners F, for attaching structural attachment member 11 to framing member FM. As can be seen, finger 15 extends in a direction generally opposite carrier arm 12 and indexes against edge E of frame member FM to locate carrier arm 12 at a set and pre-selected distance D from edge E.

Insert end 24 of cable connector 20 is passed through aperture 16 from a first side of carrier arm 12 until head 22 abuts against carrier arm 12. Cable connector 20 is then passed over conductor C1 and insert end 24 is inserted through aperture 17 from a second side of carrier arm 12. Cable connector 20 is then passed over conductor C2 and insert end 24 is inserted through aperture 18 again from the first side of carrier arm 12. Cable connector 20 is then passed over conductor C3 and insert end 24 is inserted through aperture 19 from the second side of carrier arm 12. Cable connector 20 may be drawn tight at any stage of the described operation securing and positioning any given conductor C1-C3 against carrier arm 12.

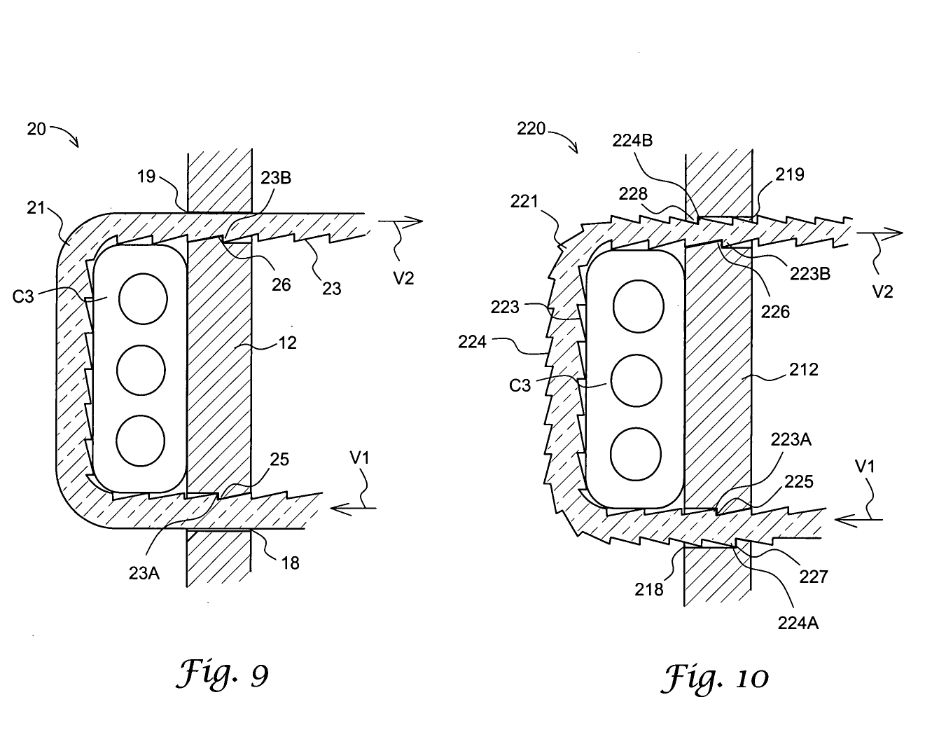

Referring to FIG. 9, a side view cutaway detail, shows carrier arm 12 including apertures 18 and 19. Conductor C3 is positioned against carrier arm 12 and is maintained in position by placement of connector body 21 of cable connector 20 about conductor C3. FIG. 9 shows to advantage the cooperating and engaging arrangement of teeth 23A and 23B with retaining pawls 25 and 26 respectively. As connector body 21 of cable connector 20 is passed through aperture 18, retaining pawl 25 engages teeth 23 until retaining pawl 25 engages tooth 23A holding tooth 23A in ratcheting engagement thereby providing a resistance to pullout of connector body 21 of cable connector 20 in the direction indicated generally by the arrow V1. Similarly, cable connector 20 is passed about conductor C3 and through aperture 12, with retaining pawl 26 engaging teeth 23 until retaining pawl 26 engages tooth 23B holding tooth 23B in ratcheting engagement, thereby pulling conductor C3 securely against carrier arm 12 and providing a resistance to pullout of cable connector 20 in the direction indicated generally by the arrow V2.

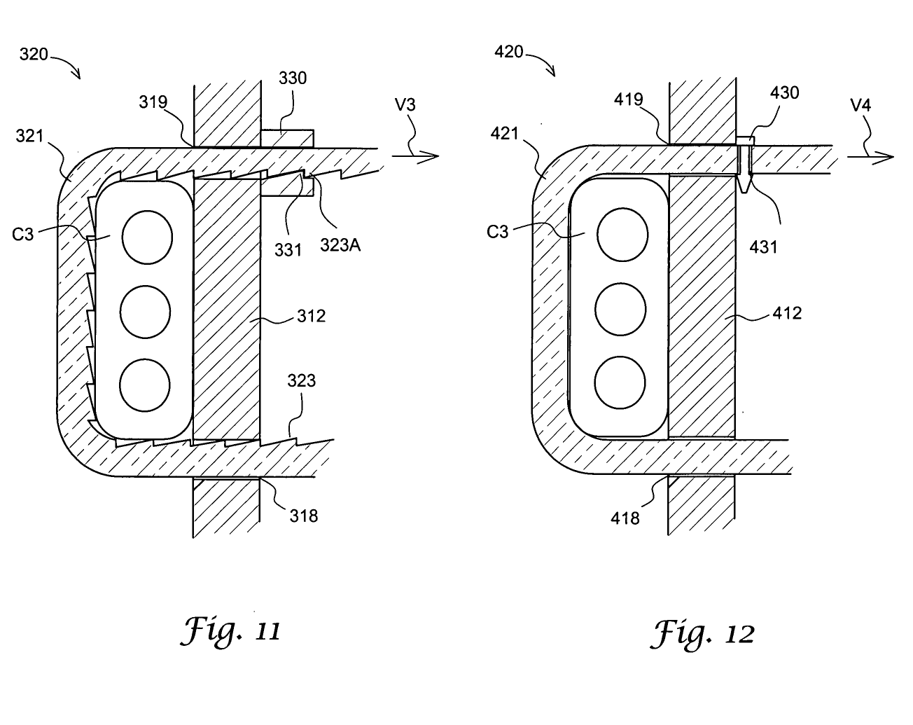

Referring to FIG. 10, a side view cutaway detail, shows carrier arm 212 including apertures 218 and 219. Conductor C3 is positioned against carrier arm 212 and is maintained in position by placement of connector body 221 of cable connector 220 about conductor C3. FIG. 10 shows connector body 221 of cable connector 220 including a first side of connector body 221 including teeth 223 and a second side of connector body 221 including teeth 224. FIG. 10 shows to advantage the ratcheting engagement of retaining pawls 225 and 227 with teeth 223A and 224A respectively and the cooperating and the ratcheting engagement of retaining pawls 226 and 227 with teeth 223B and 224B respectively. As connector body 221 of cable connector 220 is passed through aperture 218, retaining pawl 225 engages teeth 223 until retaining pawl 225 engages tooth 223A holding tooth 223A in ratcheting engagement. Similarly, retaining pawl 227 engages teeth 224 until retaining pawl 227engages tooth 224A holding tooth 224A in ratcheting engagement. Resistance to pullout of cable connector 220 in the direction indicated generally by the arrow VI is thereby accomplished. Similarly, cable connector 220 is passed about conductor C3 and through aperture 219, with retaining pawl 226 engaging teeth 223 until retaining pawl 226 engages tooth 223B holding tooth 223B in ratcheting engagement. Similarly, retaining pawl 228 engages teeth 224 until retaining pawl 228 engages tooth 224B holding tooth 224B in ratcheting engagement. Resistance to pullout of cable connector 220 in the direction indicated generally by the arrow V2 is thereby accomplished.

Referring to FIG. 11, a side view cutaway detail, shows carrier arm 312 including apertures 318 and 319. Conductor C3 is maintained in position by placement of cable connector 320 about conductor C3. Connector body 321 of cable connector 320 including teeth 323. Retaining pawl 331 of nut 330 engages tooth 323A holding tooth 323A in ratcheting engagement. As connector body 321 is passed through apertures 318 and 319, slack is taken out of cable connector 320 by pulling tightly on cable connector 320 to pull conductor C3 securely against carrier arm 312. Resistance to pullout of cable connector 320 in the direction indicated generally by the arrow V3 is provided by nut 330 which is slid along connector body 321 until retaining pawl 331 engages tooth 323A.

FIG. 12 shows a side view cutaway detail of an alternate embodiment of the invention wherein carrier arm 412 including apertures 418 and 419. Once again, conductor C3 is maintained in position by placement of cable connector 420 about conductor C3. In this embodiment, the retainer engagement element includes one or more apertures 430 formed through connector body 421 and the connector retaining element includes pin 431. Slack is taken out of cable connector 420 by pulling tightly on cable connector 420 to pull conductor C3 securely against carrier arm 412. Resistance to pullout of cable connector 420 in the direction indicated generally by the arrow V4 is provided by pin 431.

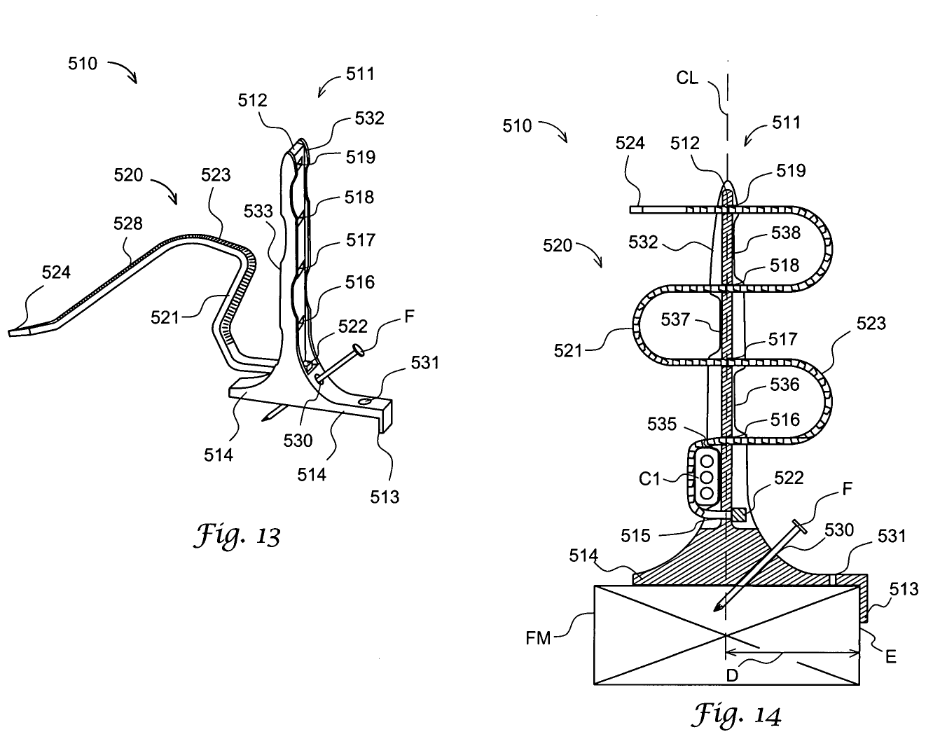

Referring to FIGS. 13 and 14, an alternate preferred embodiment, conductor support 510 includes structural attachment member 511 and a cable connector 520. Structural attachment member 511 includes base element 514 and carrier arm 512 connected to and extending from base element 514. As can be seen, finger 513 extends in a direction generally opposite carrier arm 512 and as shown in FIG. 14, indexes against edge E of frame member FM to locate carrier arm 512 at a set and pre-selected distance D from edge E. Carrier arm 512 is formed having apertures 515, (shown in FIG. 14), and 516-519 formed through a cross-section of carrier arm 512. In the embodiment shown in FIGS. 13 and 14, carrier arm 512 is formed including flanges 532, (shown in FIGS. 13 and 14), and 533, (shown in FIG. 14), which improve the strength of conductor support 510 particularly, the resistance of carrier arm 512 to flexure. Base element 514 includes one or more apertures 530 and 531 formed through a cross-section of base element 514 for insertion and passage of a fastener F for attaching structural attachment member 511 to a framing member. Cable connector 520 includes a plurality of teeth 523 spaced along a length of a top surface 528 of connector body 521. Insert end 524 is sized and configured for passage through apertures 515, (shown in FIG. 14), and 516-519.

As seen in FIGS. 13 and 14, cable connector 520 includes a connector body 521, an insert end 524 and a head 522 formed at a second end. Cable connector 520 includes a plurality of teeth 523 formed along a first surface 528 of connector body 521. Referring to FIG. 14, cable connector 520 is employed to secure conductor C1 in position relative to carrier arm 512 and therefore frame member FM. Base element 514 is shown positioned on framing member FM and includes apertures 530 and 531 formed through a cross-section of base element 514 for insertion and passage of a fastener F for attaching structural attachment member 511 to a framing member FM. Carrier arm 512 is formed having a series of cutaways 535-538 formed on alternating sides of carrier arm 512. Cutaways 535-538 are configured to permit placement of a conductor, for instance C1, as close to centerline CL as feasible. Finger 515 extends in a direction generally opposite carrier arm 512 and indexes against edge E of frame member FM to locate carrier arm 512 at a set and pre-selected distance D from edge E.

Insert end 524 of cable connector 520 is passed through aperture 515 from a first side of carrier arm 512 until head 522, seen in FIGS. 13 and 14, abuts against carrier arm 512. Cable connector 520 is then passed over conductor C1 and insert end 524 is inserted through aperture 516 from a second side of carrier arm 512. This process may be repeated to attach up to 4 conductors to conductor support 510.

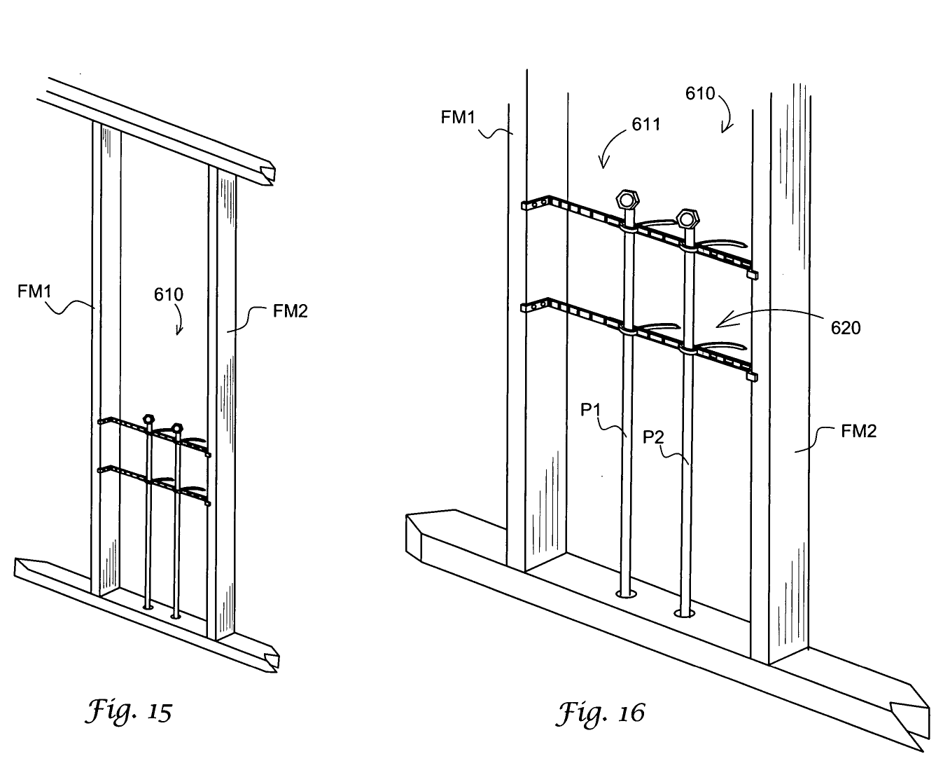

Referring to FIGS. 15 and 16, conductor support 610 is seen in use in an installed position attached to frame members FM1 and FM2. As seen in FIG. 16, conductors P1 and P2, in this case tubing, is run generally parallel to frame members FM1 and FM2. Conductors P1 and P2 are attached to conductor support 610 using a pair of structural attachment members 611 and cable connectors 620.

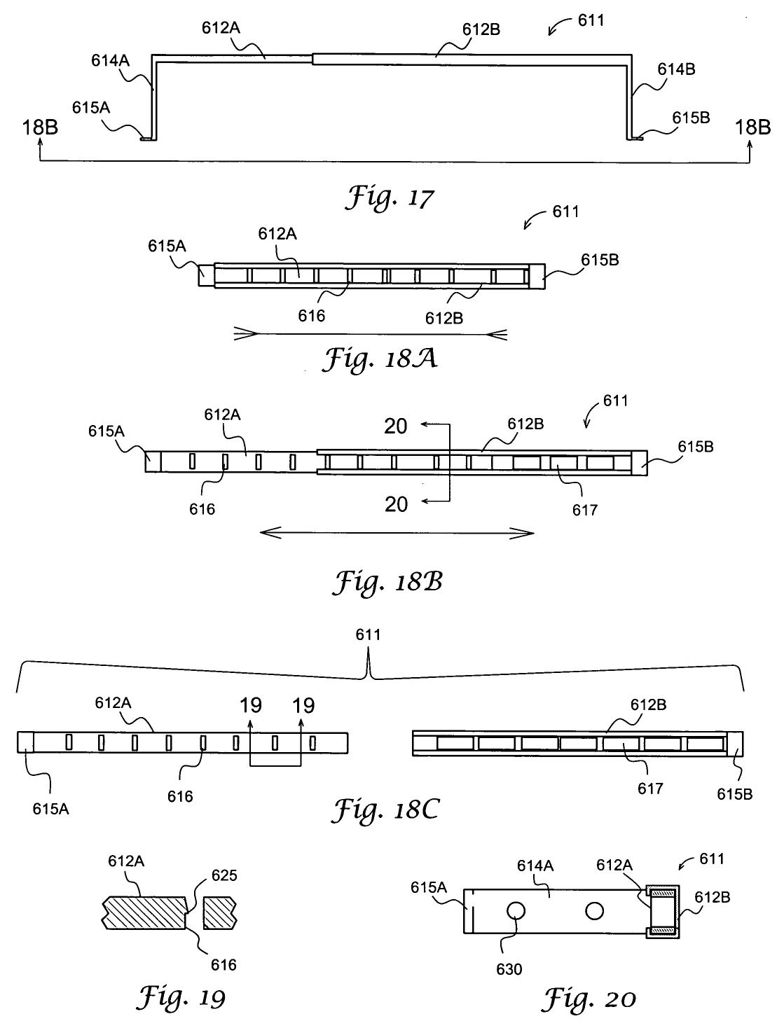

Referring to FIGS. 17 through 18C, structural attachment member 611 includes first base element 614A and a first carrier arm element 612A connected to and extending from the first base element 614A. Structural attachment member 611 also includes second base element 614B including second carrier arm element 612B connected to and extending from second base element 614B. First base element 614A and second base element 614B include fingers 615A and 615B which are connected to and extend from first base element 614A and second base element 614B respectively. Second carrier arm element 612B is slideably engageable with first carrier arm element 612A to provide a structural attachment member 611 that is capable of spanning between two adjacent frame members as shown in FIGS. 15 and 16.

As seen in FIGS. 18A through 18C, first carrier arm element 612A includes one or more cable connector receiving apertures 616 formed through a cross-section of first carrier arm element 612A. As seen in FIGS. 18B and 18C, second carrier arm element 612B includes one or more cable connector clearance apertures 617 formed through a cross-section of second carrier arm element 612B.

FIG. 19 is a partial cutaway view of first carrier arm element 612A showing retaining pawl 625 located in cable connector receiving aperture 616. Retaining pawl 625 provides ratcheting engagement against at least one of the plurality of teeth of cable connectors 620, shown in FIG. 16.

FIG. 20 is side view of structural attachment member 611 showing first base element 614A including a pair of fastener apertures 630 adapted to permit passage of a fastener for attaching structural attachment member 611 to a framing member as shown in FIGS. 15 and 16. FIG. 20 also shows second carrier arm element 612B including a generally C-shape cross-section adapted to permit sliding engagement of first carrier arm element 612A with second carrier arm element 612B thereby permitting adjustment of a distance between first base element 614A and second base element 614B.

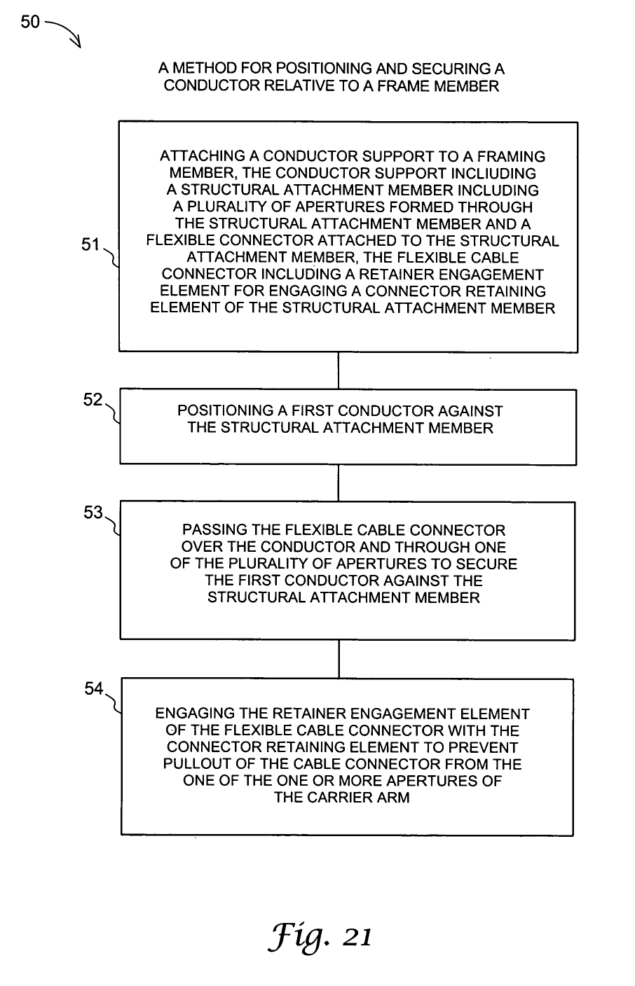

Referring to FIG. 21 a METHOD FOR POSITIONING AND SECURING A CONDUCTOR RELATIVE TO A FRAME MEMBER 50 is shown to advantage. A METHOD FOR POSITIONING AND SECURING A CONDUCTOR RELATIVE TO A FRAME MEMBER 50 Includes the steps of ATTACHING A CONDUCTOR SUPPORT TO A FRAMING MEMBER, THE CONDUCTOR SUPPORT INCLUDING A STRUCTURAL ATTACHMENT MEMBER INCLUDING A PLURALITY OF APERTURES FORMED THROUGH THE STRUCTURAL ATTACHMENT MEMBER AND A FLEXIBLE CONNECTOR ATTACHED TO THE STRUCTURAL ATTACHMENT MEMBER, THE FLEXIBLE CABLE CONNECTOR INCLUDING A RETAINER ENGAGEMENT ELEMENT FOR ENGAGING A CONNECTOR RETAINING ELEMENT OF THE STRUCTURAL ATTACHMENT MEMBER 51, POSITIONING A FIRST CONDUCTOR AGAINST THE STRUCTURAL ATTACHMENT MEMBER 52, PASSING THE FLEXIBLE CABLE CONNECTOR OVER THE CONDUCTOR AND THROUGH ONE OF THE PLURALITY OF APERTURES TO SECURE THE FIRST CONDUCTOR AGAINST THE STRUCTURAL ATTACHMENT MEMBER 53 and ENGAGING THE RETAINER ENGAGEMENT ELEMENT OF THE FLEXIBLE CABLE CONNECTOR WITH THE CONNECTOR RETAINING ELEMENT TO PREVENT PULLOUT OF THE CABLE CONNECTOR FROM THE ONE OF THE ONE OR MORE APERTURES OF THE CARRIER ARM 54.

As the invention has been described, it will be apparent to those skilled in the art that the same may be varied in many ways without departing from the spirit and scope of the invention. Any and all such modifications are intended to be included within the scope of the appended claims. It should be known that the features of cable connector 20 are not exclusive and could be readily interchanged to create additional embodiments. For example, teeth 23 may have a variety of configurations so long as ratcheting engagement with retaining pawl 25 is achieved. Similarly, attachment member 11 may be configured to accept any number of conductors from one or more for attachment consistent with the teaching of the present invention. Additionally, while structural attachment member 11 is preferably formed of a material such as a plastic or elastomer and can be manufactured through conventional injection molding techniques, it will be appreciated by those skilled in that art that other materials and other manufacturing techniques may be employed to accomplish the objective of the claimed invention.

1. A conductor support comprising:
a structural attachment member including a base element and a carrier arm connected to and extending from the base element, the carrier arm including one or more apertures formed through a cross-section of the carrier arm;
a flexible cable connector including a connector body, a retainer engagement element and an insert end configured for insertion through the one or more apertures of the carrier arm; and
a connector retainer including a connector retaining element engagable with the retainer engagement element to restrict pullout of the cable connector.

2. The conductor support of claim 1 wherein the base element further comprises a finger connected to and extending from the base element with an orientation substantially perpendicular to the base element, finger extending in a direction generally opposite carrier arm.

3. The conductor support of claim 1 wherein the cable connector further comprises a head formed at a second end of the connector body, the head configured to prohibit passage through the one or more apertures formed through the carrier arm.

4. The conductor support of claim 1 wherein the cable connector further comprises the connector body formed integrally to the carrier arm.

5. The conductor support of claim 1 wherein the cable connector further comprises the connector body connected to the carrier arm.

6. The conductor support of claim 1 wherein the carrier arm further comprises the connector retainer and the connector retaining element comprises a retaining pawl formed in one or more of the one or more apertures formed through the carrier arm, and wherein the retainer engagement element comprises plurality of teeth formed along a surface of connector body, the retaining pawl engaging of each of the plurality of teeth sequentially as the cable connector is inserted through the at least one of the one or more apertures, the retaining pawl providing a ratcheting engagement against at least one of the plurality of teeth.

7. A conductor support comprising:
a structural attachment member including a first base element and a first carrier arm element connected to and extending from the first base element, the first carrier arm element including one or more cable connector receiving apertures formed through a cross-section of the first carrier arm element;
a flexible cable connector including a connector body and a plurality of teeth formed along a surface of connector body of cable connector, an insert end and the connector body of cable connector configured for insertion through the one or more cable connector receiving apertures formed through a cross-section of the first carrier arm; and
a retaining pawl formed within at least one of the one or more cable connector receiving apertures of the carrier arm, the retaining pawl engaging of each of the plurality of teeth as the cable connector is inserted through the at least one of the one or more cable connector receiving apertures, the retaining pawl providing a ratcheting engagement against at least one of the plurality of teeth.

8. The conductor support of claim 7 wherein the structural attachment member further comprises a second base element including a second carrier arm element connected to and extending from the second base element, the second carrier arm element including one or more cable connector clearance apertures formed through a cross-section of the second carrier arm element, the second carrier arm element engageable with the first carrier arm element.

9. The conductor support of claim 8 further comprising the second carrier arm element slideably engageable with the first carrier arm element.

10. The conductor support of claim 7 wherein the base element further comprises a finger connected to and extending from the base element with an orientation substantially perpendicular to the base element, finger extending in a direction generally opposite carrier arm.

11. The conductor support of claim 7 wherein the cable connector further comprises a head formed at a second end of the connector body.

12. The conductor support of claim 7 wherein the cable connector further comprises the connector body is formed integrally to the carrier arm.

13. The conductor support of claim 7 wherein the cable connector further comprises the connector body connected to the carrier arm.

14. A method for positioning and securing a conductor relative to a frame member including the steps of:
attaching a structural attachment member to a framing member, the structural attachment member including a carrier arm including one or more apertures;
attaching a flexible cable connector including a retainer engagement element to the structural attachment member;
positioning a first conductor against a first side of the carrier arm;
passing the flexible cable connector over the conductor and through one of the one or more apertures of the carrier arm to secure the first conductor against a first side of the carrier arm; and
engaging the retainer engagement element of the flexible cable connector with a connector retaining element to prevent pullout of the cable connector from the one of the one or more apertures of the carrier arm.
